(19) United States
(12) Patent Application Publication
(10) Pub. No.: US 2023/0393819 A1
(43) Pub. Date: Dec. 7, 2023

(54) AUTOMATION SYSEM ENGINEERING USING VIRTUAL OBJECTS WITH EMBEDDED INFORMATION

(71) Applicant: Siemens Aktiengesellschaft, Munich (DE)

(72) Inventor: Richard Gary McDaniel, Hightstown, NJ (US)

(73) Assignee: Siemens Aktiengesellschaft, Munich (DE)

(21) Appl. No.: 18/246,542

(22) PCT Filed: Sep. 30, 2020
(86) PCT No.: PCT/US2020/053427

§ 371 Date: Mar. 24, 2023

(51) Int. Cl. G06F 8/34; G06F 3/04815; G06F 3/04847; G06F 8/20; G06F 8/35

(52) U.S. Cl. CPC G06F 8/34; G06F 3/04815; G06F 3/04847; G06F 8/24; G06F 8/35

(57) ABSTRACT

System and method develop a control program for operating an automation system in a manufacturing process. A design software application includes an object generator module and an editor module. Object generator module generates a plurality of virtual objects having embedded information related to an automation process, the virtual objects representing automation components to be controlled by the control program and work product parts to be manipulated for the manufacturing process. Editor module arranges, using a graphical user interface, the plurality of virtual objects in a virtual workspace, the virtual workspace representing a configuration of the automation system. The control program is developed by the arrangement of virtual objects in the virtual workspace.

### TECHNICAL FIELD

This application relates to automation software. More particularly, this application relates to embedding information into virtual components and work products for improved development of control programming in automation systems.

### BACKGROUND

Programming automation controls is ordinarily tedious and error prone. Programmers use primitive languages to specify minute functions. These functions are in no way indicative of the problem being solved and the programs that are usually written are brittle and will fail if any part of the automated system is changed.

Programs are written for various devices and controllers using commands that are specific to actuators of a given device. For example, a robot may be moved so that its end effector is placed at specific coordinates in space relative to the robot's base. Many way points may be collected to make continuous movements, but the device is always directed to perform a specific sequence of actions. The result of these actions or the goal of the application is never specified. Such programs are not skill-based but are incidentally determined by what objects are physically proximate to the running devices and what moves are being carried out.

### SUMMARY

This disclosure introduces a system and method to facilitate development of a control program for an automation system, where a developer can construct the control program in a simplified manner using a graphical user interface to arrange virtual objects representing machines, components, and work products of the automation system. The virtual objects have embedded information that include skill-based features of components as well as manipulation markers for work products. Such embedded information directs the control program instruction as the virtual objects are arranged and related to one another by the graphical user interface operations.

In an aspect, a computing system develops a control program for operating an automation system in a manufacturing process, the computer system including a processor and a non-transitory memory having stored thereon modules of a design software application executed by the processor. The modules include an object generator configured to generate a plurality of virtual objects having embedded information related to an automation process. The virtual objects represent automation components to be controlled by the control program and work product parts to be manipulated for the manufacturing process. An editor module is configured to arrange, using a graphical user interface, the plurality of virtual objects in a virtual workspace representing a configuration of the automation system. The control program is developed by the arrangement of virtual objects in the virtual workspace.

In an aspect, a computer based method develops a control program for operating an automation system in a manufacturing process. A plurality of virtual objects is generated having embedded information related to an automation process, the virtual objects representing automation components to be controlled by the control program and work product parts to be manipulated for the manufacturing process. Using a graphical user interface, the plurality of virtual objects is arranged in a virtual workspace representing a configuration of the automation system. The control program is developed by the arrangement of virtual objects in the virtual workspace.

### BRIEF DESCRIPTION OF THE DRAWINGS

Non-limiting and non-exhaustive embodiments of the present embodiments are described with reference to the following FIGURES, wherein like reference numerals refer to like elements throughout the drawings unless otherwise specified.

FIG. 1 shows an example of generating an automation application using virtual objects with embedded skill knowledge in accordance with embodiments of this disclosure.

FIG. 2 shows an example for implementation of embedding directed instructions for a virtual component of an automation system in accordance with embodiments of this disclosure.

FIG. 3 shows an example of embedding skills for a virtual component related to work product parts of an automation system in accordance with embodiments of the disclosure.

FIG. 4 shows examples of embedded information for a stacking operation in accordance with embodiments of this disclosure.

FIG. 5 illustrates an example of a computing environment within which embodiments of the disclosure may be implemented.

### DETAILED DESCRIPTION

Methods and systems are disclosed for embedding high level component based programming into virtual automation machines and devices for developing automation control programs for the real automation machines and devices. The software programming is skill-based and stores skill instructions within the application components rather than having the user specify programs at the global application level.

The disclosed system and method allow an automation application to be created using editing of graphical objects representing the physical appearance of the devices in the system. A graphical user interface is configured to present available objects to a user. An editor function enables the user to drag objects from a list or table onto a virtual workspace to represent a plurality of automation devices, work products, transportation devices, robotics, and other contributing elements for a system design. The virtual objects may include embedded skill knowledge related to a task objective according to the disclosed embodiments, such as a combination of instructions for the component and for an interfacing external component. In some instances, markers may be embedded in a virtual object to indicate implicit behavior, such as how work product will move on a component surface. Virtual work product objects may have bill of process (BOP) information embedded, such as specifying manipulations to the work product and conditional operations. The disclosed systems and methods provide a technical improvement to conventional automation control program development in that virtual objects with preprogrammed skill-based markers are manipulated on a graphical user interface enabling knowledge infused programming for automation devices that when executed, allow goal oriented tasks to be performed (e.g., stack a set of objects until all objects are stacked) rather than a fixed step-by-step algorithm of movements and positions.

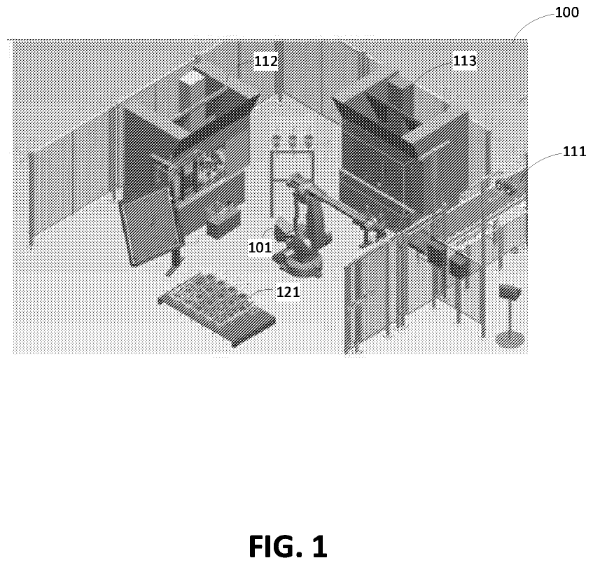

FIG. 1 shows an example of generating an automation application using virtual objects with embedded skill knowledge in accordance with embodiments of this disclosure. In an embodiment, a design software application for designing an automation system is configured to enable a user, such as a programmer or systems engineer, to construct a systems design and control program for automation system components. The design software application may be deployed and executed on a computing device comprising a processor, memory, and a graphical user interface. Data for the design software application may be stored in local memory, or may be remotely stored for retrieval by the computing device. As an illustrative example of an automation system design generated by the design software application, FIG. 1 shows a virtual workspace 100 in which various virtual automation system components are arranged for an automated manufacturing process. For this example, the virtual components include a central robot 101 is configured to tend a conveyor 111, a computer numerical control (CNC) machine 112, and a washing machine 113, which are arranged to process a work product 121 (e.g., motor cylinders that are to be milled, burnished, washed, and stacked for transport). The design software application furnishes virtual objects, such as robot 101, conveyor 111, and CNC machine 112, in a component library that may be stored in local memory or remote storage. When adding a new virtual object to the virtual workspace 100, the design software application may present available objects to a user as a list, table, graphical representation, or combination thereof. During the design process, a user may select an object using the graphical user interface to drag the object into the virtual workspace 100. An editor module of the design software application attaches objects to one another in response to user actions with graphical user interface tools (e.g., computer aided design (CAD) graphical editing tools). In response to user commands (e.g., drag and drop operations executed on the graphical user interface), the editor module arranges virtual objects in the workspace 100 so that 3D positions of virtual objects correspond precisely with an arrangement in the real factory environment. Accordingly, the virtual arrangement in the virtual workspace 100 is a digital twin of the real factory. In an aspect, virtual objects may be attached to one another by a snap-on feature of the editor, such as to connect a virtual subcomponent to a virtual component (e.g., a gripper to a flange of the robot 101), in order to simplify the editing process. In an embodiment, each virtual object includes preprogrammed functionality in the form of embedded knowledge. By constructing the virtual workspace 100 with these preprogrammed virtual objects, the automation system is designed to include movements of the robot 101 and all other devices 111, 112, 113 without requiring further programming for specific control functions. The design software application constructs the automation system design using the virtual objects that are essentially pre-programmed with knowledge about how each object is used and how the work product 121 is produced. The pre-programmed knowledge is encoded and embedded into the virtual objects using markers, which will be described below in greater detail.

In contrast with conventional approaches for programming an automation device according to specific coordinates in space relative to base coordinates, or according to strictly trajectory-based commands, the design software application of this disclosure encodes knowledge-based behavior into each of the virtual objects (representing automation machines in the factory). The embedded knowledge relates to how a machine is to be used with respect to a work product result, avoiding a control program for a machine having constraints with respect to specific situation-based deployment. For example, embedded knowledge for a machine (e.g., conveyor 111) that must be loaded with work product 121 or an assembly part needs to relate what kinds of work product or parts are applicable and how they are to be loaded onto the machine (e.g., position, approach, orientation, etc.). The design software application embeds knowledge such that the control program can be agnostic as to what kind of external device (e.g., robot 101), or person, is executing the loading of the work product 121 or assembly part. The embedded knowledge may include a partial specification of the external device and is parameterized with knowledge about the device doing the loading in order to function. The parameters are task specific and will vary accordingly. In an aspect, parameters may include relative positioning information, kinds of grippers that may be applied, direction of approach, and reflection/rotation constraints. Parameters need not distinguish as to whether a human or machine is loading work product 121 in the work process, as an objective is for automated machines to be programmed with embedded skills. An example of parameterized knowledge information for an implemented work process that combines automation with human involvement would be for an automated checking device that uses the embedded knowledge information to check that human work tasks are correctly and completely performed.

In an embodiment, the design software application creates machine instructions that are particular to a given device but are vague in terms of external components (such as devices that interact with the device of interest) or users of the device. In contrast to conventional control programs for automation devices that specify every detail for all devices involved in an operation, the design software application of this disclosure defines a control program that specifies instructions with respect to the machine or component for which the instructions are applied. All other features, such as features pertaining to external objects that interact with the component of interest, are parameterized as abstract descriptions and general behaviors. The markers are the primary means for parameterization. Markers can be used to show relationships between objects as well as process related information. Another form of parameterization is task sequence via the set of skills to be applied. As the tasks are split between machines (e.g., robot 101, conveyor 111), a task sequence itself is not a complete automation program.

In addition, instructions for an individual component are not specified as to when they occur in relation to other instructions. Instead, instructions may be executed as needed by the overall system and may also be executed in parallel if possible. In an embodiment, the design software application defines a separate control program for each component in the workspace instead of a single encompassing control program for a tandem of devices working together. The machine instructions are partial programs, loosely like a procedure or function. An overall control program is a general scheduler and search algorithm, with an objective to find paths through the instructions that complete work products. There may be several possible paths available at a given time and a scheduler component is configured to select which instruction set to currently execute. The assembly of the virtual machine objects, each having respective control programs, into an aggregate factory as shown in FIG. 1, brings together the sets of instructions and markers.

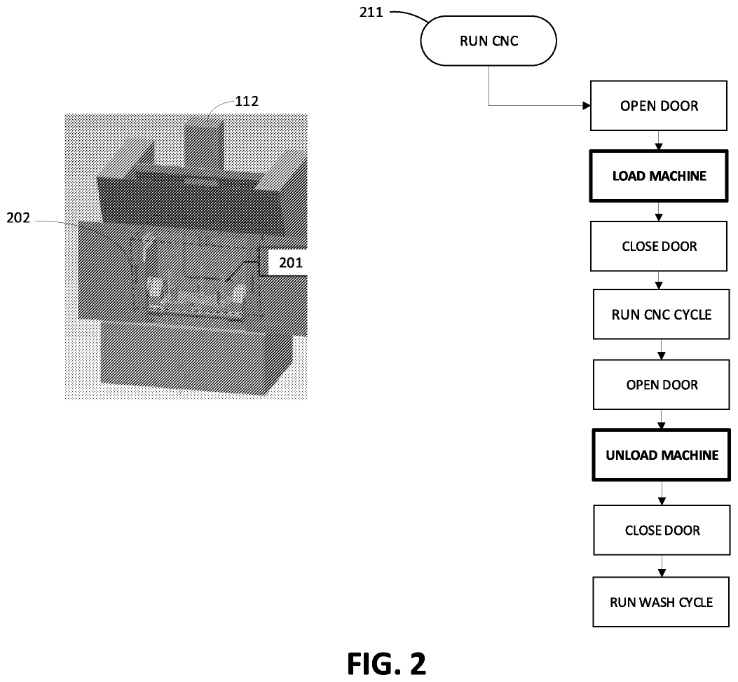

FIG. 2 shows an example for implementation of embedding directed instructions for a virtual component of an automation system in accordance with embodiments of this disclosure. In an embodiment, embedded instructions for a virtual component may include some instructions directed at another virtual component. In this illustrative example, a virtual CNC machine 112 is shown with an embedded instruction set of high-level instructions 211, without hardware specific details. In this example, the CNC machine 112 is configured to perform milling of a workpiece. The sequence of functions for Run CNC instruction set 211 may be applied in order, starting from opening the door of the machine, loading the machine, closing the door, running the CNC cycle, unloading the machine, closing the door, and finally running a wash cycle. For each instruction that is specific to the CNC machine 112, the encoded instruction may include further details (not shown), such as which signals are to be produced for activating the wash cycle, and how to precisely move armatures of the CNC 112 in order to mill the workpiece. However, two of the shown functions in the sequence are not a task for the CNC machine. These are the load and unload machine functions, which are instead directed to be performed by some external component (e.g., robot 101) that is tending the CNC machine 112. The load and unload functions provide instruction for the external component and provide parameterization to the external component so that the external component can perform the task correctly. The markers are the source for parameters that the load and unload instructions can provide for the external entity. The external entity that actually performs the load and unload task can incorporate the paths, object types, positions, and orientations that will determine exactly how the external entity can perform the task.

In an embodiment, the parameters are communicated, in part, to the external component in the form of markers, as shown in the graphical interior of the virtual CNC machine 112 to indicate where work products are to be placed within the machine during the loading operation. The control program contains adaptors for each machine with which it must communicate and execute actions. These adaptors are custom for each machine (e.g., the robot 101) but are reusable for a variety of tasks. Some instruction sets, such as Run CNC Cycle 211, may be tied directly to adaptor actions. During runtime, after the control programs have been fully developed according to the described embodiments, a scheduler module coordinates the instruction sets that involve concurrent operation of multiple machines, such as the load and unload tasks programmed in the Run CNC 211 instruction set.

During development of the design software application, when a new part is introduced, new features of machines such as fixtures, grippers, and armatures would also be introduced if the current versions were inadequate, providing an opportunity to place markers for new kinds of objects. Markers are also attached on virtual work parts so that current tools can be shown how to be applied. In an aspect, more than one distinct marker may be embedded to a virtual object (e.g., a first marker related to how a machine is to pick up a work product and a second marker related to how the machine is to place the object, which may be represented graphically as upward and downward arrows, respectively).

As shown in FIG. 2, the markers for “unload machine” are graphically generated as visual aids to the user on a graphical user interface as upward arrows 201. A region marker 202 is also shown in FIG. 2, configured as a dashed box that encloses the region of the CNC machine 112 where parts are to be placed and retrieved. These markers 201, 202 are considered part of the virtual object of the CNC machine 112 and are instantiated with the virtual CNC machine 112. The markers may contain information that is pertinent to the work product that the CNC machine 112 will manipulate. For example, the markers may contain information related to the type of work product, such as a cylinder object, as well as the place where the work product must be set in the CNC machine 112, and the path the work product must be moved in order to insert the item into the machine successfully. The ontology of the markers may be predefined as well as the skill instructions that interpret them. The designed automation system consists of dynamically loaded virtual objects, so extension for new markers and skills are possible. The markers are by definition sets of parameters than can be retrieved on demand. The skills that use the markers encode the knowledge for how to retrieve and use it. Indirect references may be used to select which markers are pertinent for a given situation.

In an embodiment, the markers related to the work product may be part of the object for the component on which it will be loaded, such as CNC object itself, or the markers may be stored as attachments to subcomponents, such as jigs or other holding devices within the virtual CNC machine 112. Thus, instead of encoding information about how to load and unload the CNC machine directly in the CNC machine's object as described above, the parameterization may be delegated to the subcomponents within the virtual CNC machine 112. For example, the jigs, clamps, or other attachment devices may store the marker information about how a work product is loaded or removed and the CNC machine 112 may use that information for detailing how to use the attachment device during the loading or unloading operation.

Not all components must incorporate embedded instructions. In an embodiment, some components in the virtual workspace may have embedded functional markers that indicate a relationship between objects with a functional purpose. For example, virtual objects to be gripped, such as work product parts, may be embellished with grip markers according to embodiments of this disclosure. In an embodiment, free moving objects (e.g., a work product part, a vacuum gripper tool, or a work product stacking separator) may be paired with a grip marker to show how the object is intended to be gripped. In an embodiment, the functional purpose encoded in the marker may include approach direction, which may be represented graphically as a directional arrow as a visualization aid for the user at a graphical user interface. Other visualization aids, such as such as a property editor where the developer can access other parameters, may be provided. In an aspect, the editor module may show more graphical embellishments when an object is selected (e.g., selection handles). While it is unknown a priori which device might employ that particular type of gripper or even if that gripper will be employed at all, once the control program determines that a particular object needs to be picked up, the method for applying a gripper can be retrieved from the preset embedded marker of the object for easy reference. For example, the virtual object of the work product may have an embedded marker related to the required grip marker.

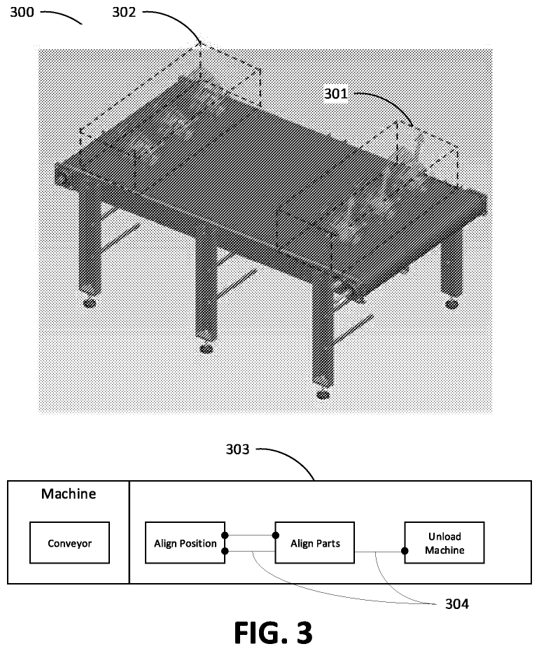

FIG. 3 shows an example of embedding skills for a virtual component related to work product parts of an automation system in accordance with embodiments of the disclosure. In an embodiment, components may derive function from embedded skill related instructions as described above for FIG. 2, and may also possess behavior that is implicitly defined as now described. A virtual conveyor 300, as shown in FIG. 3, may be displayed on a graphical user interface as part of the virtual workspace 100 of FIG. 1. Virtual conveyor 300 has embedded instructions 303, which may also be displayed on the graphical user interface as shown in FIG. 3. Instructions 303 are related to arrangement of work product parts, such as align position on the conveyor surface, align parts with respect to one another, and unload machine. Marker attachments 304 provide a graphical indication that a marker has been successfully attached to a parameter skill for a virtual object, such as virtual conveyor 300. With respect to the unloading instruction, additional graphical instructions 301 are embedded using the graphical user interface to denote which parts need to be unloaded by the dashed boxes and upward arrows.

In an embodiment, the virtual conveyor object 300 itself implicitly defines how parts move on its surface. The markers do not indicate whether the conveyor is turned on or off. Instead the markers show where work products should be parked (e.g., marker 301) to be ready for a pick function of another entity, such as the robot 101. The conveyor has to operate precisely for a duration, speed, and/or distance that will properly position the parts on its surface. As such, controls for stop, start, and speed of the conveyer depend on moving current parts so that they are picked up according to the required objective of the work flow process (e.g., assembly). Such parameters are implicitly defined by the marker 301 park location. As such, the design software application developer does not necessarily need prior knowledge about the details for how parts move on the conveyor, which parts are currently on the conveyor, or how to show the motion with an explicit path. Thus, this embodiment for the implicit marker provides a different form of embedded function than the more explicit unload machine marker 201 shown in FIG. 2, for example.

The parts that appear on the conveyor may also be determined by virtual objects outside the purview of virtual conveyor 300. A virtual object, such as conveyer 300, may have a work product part generating source 302 embedded at one end. The work product part instance that the developer defines could potentially be any work product part. In the example as shown in FIG. 3, a parameter has been defined for a set of three cylinder objects in generating source 302. However, different patterns, number of work parts, or even a mix of different kinds of work parts may be defined by the generating source 302. The work product part generator 302 may detect what parts are in the region at the application start and may continue to produce new instances in that pattern or as they are detected in the actual plant via sensors. In a similar manner, the design software application may define work product part sink object (not shown) embedded at one end of the conveyor 301 to remove work product part objects in the virtual workspace, which may represent a work flow process in which the work product parts are to be removed from the conveyor 301 (i.e., the counterpart operation of the work product part generating source 302). Accordingly, a time series of images can be displayed on the graphical user interface to represent the complete operation of the virtual conveyor 300, showing work product parts loaded at marker 302 position (appearing via generator object), then moving down the conveyor to marker 301 position for unloading, and finally removed by work product part sink object to represent the unloaded parts.

In an embodiment, a virtual work product part is embedded with markings and a Bill of Process (BOP) for how the work product part is to be manipulated and possibly combined with other work product parts by the other various components. For example, a work product 121 may be encoded with the BOP to first knock out flashing, mill with the CNC machine 112, burnish in a grinder, and finally wash off tailings. These processes can be recognized and tracked as they are carried out by various components in the design software application. The CNC machine 112, for example, would be responsible for the milling. More than one machine may be available for a given operation and the work product part embedding may provide for different pathways to be performed in combination or in sequence. The BOP may also contain conditional operations depending on various states of the application, the work part, or outside data sources such as a database for product customization. As a work product part is processed by the various components, embedded BOP information will reflect changes to work product part state and to note that items of the BOP are completed and no longer need to be accomplished. A completed process may allow for the system to search for subsequent processes to be performed.

For work products that are to be assembled or to have various location specific operations applied to them, the virtual work product parts can be encoded with markers for noting locations on the work product part where those operations take place and how various work product parts fit together. The markers can be encoded to be relative to the work product part location so that the position does not change as the parts move through the virtual workspace. In an aspect, operations markers may include one or more of assembly locations, gluing positions, staples, insertion points, cutting locations, and all other manner of operation on a work product.

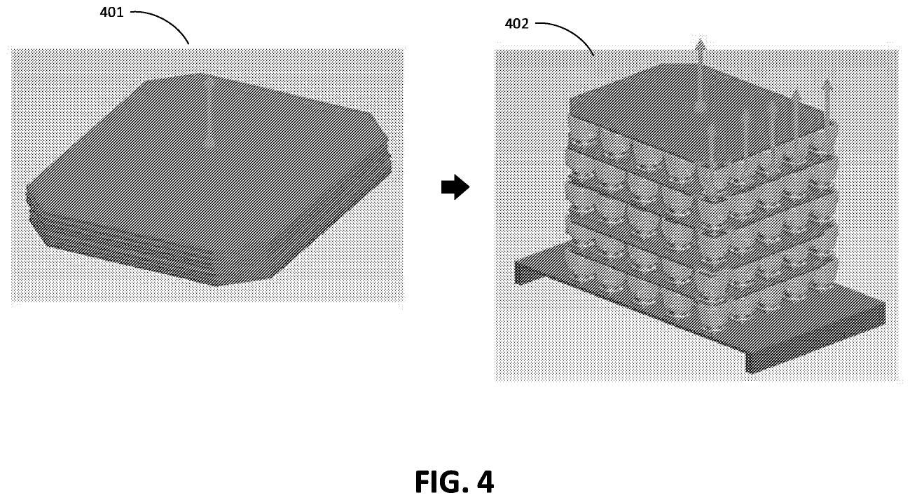

FIG. 4 shows examples of embedded information for virtual stacking objects in accordance with embodiments of this disclosure. In an embodiment, some virtual objects are neither machines nor physical objects. For example, a virtual stacking object may be used to represent stacking instructions to show how work product parts are to be stacked either for final shipping or any other part of the process. In FIG. 4, virtual stacking object 401 represents a stacking operation as a set of available separation panels for work product parts. The stacking operation, itself, is not the panels but the form and placement of the panels in a vertical stack. The graphical display of virtual stacking object 401 may evolve from a full set of stacking operations as shown in 401 to an empty set where it has no remaining panels at all, to reflect a time series of stacking operations. In an embodiment, a stacking object may have complex structure, such as for arranging work product parts in multiple stages of stacking, possible in different locations. For the example illustrated in FIG. 4, the virtual workspace may include stack 401 from which a robot may pick separation panels and cylinders to a location where work product parts are to be stacked, such as on a palette. Once all work product parts are stacked, the virtual stack may appear as shown by stacking object 402. For the purpose of constructing the control program by arrangement of virtual objects in the virtual workspace, moving markers facilitate stacking the work product parts by showing where the next item may be picked up or placed down. The embedded upward arrow marker on stack 401 represents a marker for a loading component (e.g., a robot) to find the stack 401 as one of a plurality of panel objects to be manipulated during the automation control process. Virtual stack 402 represents a stacked arrangement of work product parts shown as stacked cylinder and panel objects, each work product part having embedded markers for the next operation(s) such as pick-and-place (e.g. by robot 101 of FIG. 1) to the next destination in the work flow. An advantage of the virtual stacking object 401 is to simplify alternative virtual representations of work products, such as aggregations or assembly of objects, which require many more steps and coding complexity and would also fail to instruct a robot the skill concept of stacking.

Aspects of the stack operation, such as number of dimensions of the stack, direction the stack progresses, kinds of work products in the stack, orientations of the objects in the stack and any other relevant property, may all be defined by the developer by using the graphical user interface to arrange the stacked objects and to embed stacking operation markers. The virtual stacks could be initialized as empty or as having some number of items already in the stack. The design software application may use user input or sensor input to initialize the number of parts already in the stack. For example, in an embodiment in which the virtual workspace 100 includes virtual components and objects defined as digital twins of an actual manufacturing facility, sensors (e.g., visual sensors) may detect and recognize work product parts which can be then be simulated by the design software application to render the virtual workspace with the virtual representation of the work product parts.

Robotic devices are considered actors with volition within the context of the application. As a result, the instructions for robots are not usually fixed but are formulated as short composable fragments that seek to act on various other devices or work product parts. For example, a robot can be furnished with a notion that it can pick up a work product part and put it down in another location. While the robot is holding the work product part, it may perform activities within the part's embedded BOP such as burnishing or knocking out flashing. In an embodiment, sets of instructions may be configured as edges of a graph where end points of graph edges are markers that relate to other markers and thus can be used to join the edges as connected vertices. The embedded BOP on the work product part determines which edges must be traversed in what order. An objective is to find a path through the graph that covers all the processes in the right order. Since the software application developer seeks to have the work product parts to be processed, the graph is designed to avoid creating dead ends. Limited storage space for a work product part with embedded programming may prevent some edges from being traversed at a given time. In general, a greedy algorithm that seeks to fulfill the next operations in the BOP for work products on the production line is sufficient so long as the machine being instructed by the set of instructions is cleared upon completing the instruction set (i.e., a robot should not be left holding something after a given instruction set is complete). For more complicated cases, a scheduling algorithm may be implemented.

In an embodiment, acting devices, such as robot 101, conveyor 111, CNC machine 112, do not run a fixed sequence of instructions, but generate instructions based on searching for work products that need operations performed on them. The production state for work products includes an indication for what processes need to be performed to complete the work product. The robots or other acting devices can move to the place where the work products are located and then perform those processes or deposit the work product into a device that can perform a needed process. The acting device performing a process may need to be manipulated by another acting device. For example, an acting device may need to open the door of a component that has a door. The acting device may need to have a clear gripper to perform such an action. In order to determine what actions the acting device performs, it can test various combinations of actions and determine which ones need to occur before others in order to function correctly. For example, in order to place a panel onto the stack (e.g., stack 402 in FIG. 4), the robot must first pick up the vacuum gripper. In general, the nature of the work product being manipulated determines what actions must occur. For example, a panel that needs to be picked up may have an embedded marker that shows a vacuum gripper is needed. In addition, the vacuum gripper may have an embedded marker to show that the claw gripper is to be used to pick up the vacuum gripper. These dependencies feed into one another and the full sequence can usually be determined easily by following the path backwards from desired result to ready work product. Other, less simple searches, such as motion planning, can be calculated through other algorithms.

Acting devices, such as a robot, may have embedded markers that indicate associations with other machines to denote that it can be responsible for those machines. This can significantly reduce the amount of search needed to determine what actions a device needs to do to accomplish a work product process.

Advantages of the disclosed embodiments include accomplishing component-based programming with high-level, skill-like functions rather than low-level programming languages like C. Disclosed embodiments are novel from the skill-based programming methods described above because skill instructions are stored within the application components rather than having the user specify programs at the global application level. Further advantages include creating new design applications simply by placement of a set of physical devices preprogrammed with knowledge-based skills, along with the related work product or parts, into a virtual workspace environment. The preprogrammed actions of the devices can be inferred from reading descriptions of the devices without requiring a user to add explicit programming.

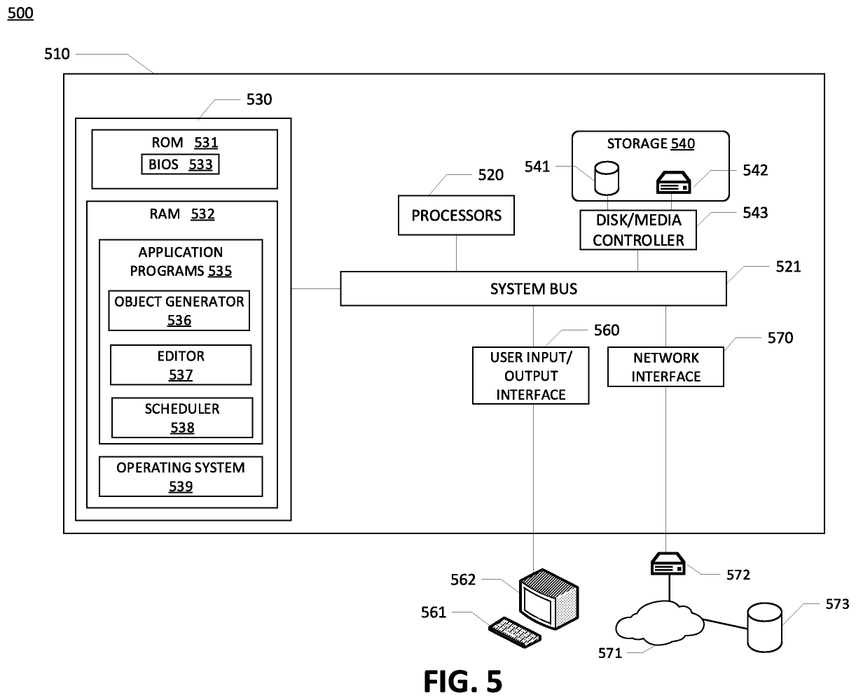

FIG. 5 illustrates an example of a computing environment within which embodiments of the present disclosure may be implemented. A computing environment 500 includes a computer system 510 that may include a communication mechanism such as a system bus 521 or other communication mechanism for communicating information within the computer system 510. The computer system 510 further includes one or more processors 520 coupled with the system bus 521 for processing the information. In an embodiment, computing environment 500 corresponds to a design software application development system, in which the computer system 510 relates to a computer described below in greater detail.

The processors 520 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 520 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 521 may include at least one of a system bus, a memory bus, an address bus, or a message bus, and may permit exchange of information (e.g., data (including computer-executable code), signaling, etc.) between various components of the computer system 510. The system bus 521 may include, without limitation, a memory bus or a memory controller, a peripheral bus, an accelerated graphics port, and so forth. The system bus 521 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 5, the computer system 510 may also include a system memory 530 coupled to the system bus 521 for storing information and instructions to be executed by processors 520. The system memory 530 may include computer readable storage media in the form of volatile and/or nonvolatile memory, such as read only memory (ROM) 531 and/or random access memory (RAM) 532. The RAM 532 may include other dynamic storage device(s) (e.g., dynamic RAM, static RAM, and synchronous DRAM). The ROM 531 may include other static storage device(s) (e.g., programmable ROM, erasable PROM, and electrically erasable PROM). In addition, the system memory 530 may be used for storing temporary variables or other intermediate information during the execution of instructions by the processors 520. A basic input/output system 533 (BIOS) containing the basic routines that help to transfer information between elements within computer system 510, such as during start-up, may be stored in the ROM 531. RAM 532 may contain data and/or program modules that are immediately accessible to and/or presently being operated on by the processors 520. System memory 530 additionally includes application modules 535 and operating system 539. Application modules 535 include components of the design software application, such as an object generator 536 configured to simulate aforementioned virtual objects, such as components, subcomponents, work product parts of the virtual workspace. Editor module 537 is configured to execute instructions for the graphical user interface to process user inputs for development of the application program, allowing input parameters to be entered and modified as necessary, while displaying the virtual objects having embedded markers as described above. Scheduler module 538 is configured to coordinate instructions sets programmed for the various respective components, including instructions that are directed to an external component.

The operating system 539 may be loaded into the memory 530 and may provide an interface between other application software executing on the computer system 510 and hardware resources of the computer system 510. More specifically, the operating system 539 may include a set of computer-executable instructions for managing hardware resources of the computer system 510 and for providing common services to other application programs (e.g., managing memory allocation among various application programs). In certain example embodiments, the operating system 539 may control execution of one or more of the program modules depicted as being stored in the data storage 540. The operating system 539 may include any operating system now known or which may be developed in the future including, but not limited to, any server operating system, any mainframe operating system, or any other proprietary or non-proprietary operating system.

The computer system 510 may also include a disk/media controller 543 coupled to the system bus 521 to control one or more storage devices for storing information and instructions, such as a magnetic hard disk 541 and/or a removable media drive 542 (e.g., floppy disk drive, compact disc drive, tape drive, flash drive, and/or solid state drive). Storage devices 540 may be added to the computer system 510 using an appropriate device interface (e.g., a small computer system interface (SCSI), integrated device electronics (IDE), Universal Serial Bus (USB), or FireWire). Storage devices 541, 542 may be external to the computer system 510.

The computer system 510 may include a user input/output interface module 560 to process user inputs from user input devices 561, which may comprise one or more devices such as a keyboard, touchscreen, tablet and/or a pointing device, for interacting with a computer user and providing information to the processors 520. User interface module 560 also processes system outputs to user display devices 562, (e.g., via an interactive GUI display).

The computer system 510 may perform a portion or all of the processing steps of embodiments of the invention in response to the processors 520 executing one or more sequences of one or more instructions contained in a memory, such as the system memory 530. Such instructions may be read into the system memory 530 from another computer readable medium of storage 540, such as the magnetic hard disk 541 or the removable media drive 542. The magnetic hard disk 541 and/or removable media drive 542 may contain one or more data stores and data files used by embodiments of the present disclosure. The data store 540 may include, but are not limited to, databases (e.g., relational, object-oriented, etc.), file systems, flat files, distributed data stores in which data is stored on more than one node of a computer network, peer-to-peer network data stores, or the like. Data store contents and data files may be encrypted to improve security. The processors 520 may also be employed in a multi-processing arrangement to execute the one or more sequences of instructions contained in system memory 530. In alternative embodiments, hard-wired circuitry may be used in place of or in combination with software instructions. Thus, embodiments are not limited to any specific combination of hardware circuitry and software.

As stated above, the computer system 510 may include at least one computer readable medium or memory for holding instructions programmed according to embodiments of the invention and for containing data structures, tables, records, or other data described herein. The term “computer readable medium” as used herein refers to any medium that participates in providing instructions to the processors 520 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 541 or removable media drive 542. Non-limiting examples of volatile media include dynamic memory, such as system memory 530. Non-limiting examples of transmission media include coaxial cables, copper wire, and fiber optics, including the wires that make up the system bus 521. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 500 may further include the computer system 510 operating in a networked environment using logical connections to one or more remote computers, such as remote computing device 573. The network interface 570 may enable communication, for example, with other remote devices 573 or systems and/or the storage devices 541, 542 via the network 571. Remote computing device 573 may be a personal computer (laptop or desktop), a mobile device, a server, a router, a network PC, a peer device or other common network node, and typically includes many or all of the elements described above relative to computer system 510. When used in a networking environment, computer system 510 may include modem 572 for establishing communications over a network 571, such as the Internet. Modem 572 may be connected to system bus 521 via user network interface 570, or via another appropriate mechanism.

Network 571 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 510 and other computers (e.g., remote computing device 573). The network 571 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 571.

It should be appreciated that the program modules, applications, computer-executable instructions, code, or the like depicted in FIG. 5 as being stored in the system memory 530 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 510, the remote device 573, and/or hosted on other computing device(s) accessible via one or more of the network(s) 571, may be provided to support functionality provided by the program modules, applications, or computer-executable code depicted in FIG. 5 and/or additional or alternate functionality. Further, functionality may be modularized differently such that processing described as being supported collectively by the collection of program modules depicted in FIG. 5 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 5 may be implemented, at least partially, in hardware and/or firmware across any number of devices.

It should further be appreciated that the computer system 510 may include alternate and/or additional hardware, software, or firmware components beyond those described or depicted without departing from the scope of the disclosure. More particularly, it should be appreciated that software, firmware, or hardware components depicted as forming part of the computer system 510 are merely illustrative and that some components may not be present or additional components may be provided in various embodiments. While various illustrative program modules have been depicted and described as software modules stored in system memory 530, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computing system for developing a control program for operating an automation system in a manufacturing process, the computing system comprising:
a processor; and
a non-transitory memory having stored thereon modules of a design software application executed by the processor, the modules comprising:
an object generator configured to generate a plurality of virtual objects having embedded information related to an automation process, the virtual objects representing automation components to be controlled by the control program and work product parts to be manipulated for the manufacturing process; and
an editor configured to arrange, using a graphical user interface, the plurality of virtual objects in a virtual workspace, the virtual workspace representing a configuration of the automation system;
wherein the control program is developed by the arrangement of virtual objects in the virtual workspace.

2. The computing system of claim 1, wherein the embedded information for a first virtual component includes skill-based machine instructions for performing one or more operations related to a task objective for the first virtual component.

3. The computing system of claim 2, wherein the embedded information for the first virtual component includes information directed at a second virtual component related to a task objective for the second virtual component, the directed information comprising parameterized features with abstract descriptions and general behaviors.

4. The computing system of claim 1, wherein the embedded information for a first virtual component includes information to indicate implicit behavior of the first virtual component.

5. The computing system of claim 1, wherein the editor is configured to attach a virtual subcomponent to a first virtual component using the graphical user interface.

6. The computing system of claim 1, wherein the embedded information for a first virtual work product part includes a bill of process for how the first work product part is to be manipulated and possibly combined with other virtual work product parts by the plurality of virtual components.

7. The computing system of claim 6, wherein the embedded information for the first virtual work product part includes markers encoded to indicate locations on the first virtual work product part where manipulations are to occur and how various other work product parts fit together to combine with the first virtual work product part.

8. The computing system of claim 1, wherein the object generator is further configured to generate a subset of virtual objects that are used only within the virtual workspace to facilitate the arrangement of virtual work product parts and that do not represent a real object in the automation system.

9. A computer based method for developing a control program for operating an automation system in a manufacturing process, the method comprising:
generating a plurality of virtual objects having embedded information related to an automation process, the virtual objects representing automation components to be controlled by the control program and work product parts to be manipulated for the manufacturing process;
arranging, using a graphical user interface, the plurality of virtual objects in a virtual workspace, the virtual workspace representing a configuration of the automation system;
wherein the control program is developed by the arrangement of virtual objects in the virtual workspace.

10. The method of claim 9, wherein the embedded information for a first virtual component includes skill-based machine instructions for performing one or more operations related to a task objective for the first virtual component.

11. The method of claim 9, wherein the embedded information for a first virtual component includes information to indicate implicit behavior of the first virtual component.

12. The method of claim 9, further comprising:
attaching a virtual subcomponent to a first virtual component using the graphical user interface.

13. The method of claim 9, wherein the embedded information for a first virtual work product part includes a bill of process for how the first work product part is to be manipulated and possibly combined with other virtual work product parts by the plurality of virtual components.

14. The method of claim 13, wherein the embedded information for the first virtual work product part includes markers encoded to indicate locations on the first virtual work product part where manipulations are to occur and how various other work product parts fit together to combine with the first virtual work product part.

15. The method of claim 9, further comprising:
generating a subset of virtual objects that are used only within the virtual workspace to facilitate the arrangement of virtual work product parts and that do not represent any real object in the automation system.
